(19) United States
(12) Patent Application Publication
(10) Pub. No.: US 2008/0281950 A1
(43) Pub. Date: Nov. 13, 2008

(54) Method and Device for Peer to Peer File Sharing

(75) Inventors: Ofer Wald, Petah Tikva (IL); Eitan Efron, Kfar Hes (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: FIRST OVERSI LTD, TEL AVIV (IL)

(21) Appl. No.: 10/598,161

(22) PCT Filed: Mar. 6, 2005
(86) PCT No.: PCT/IL2005/000260

§ 371 Date: Jul. 23, 2008

Related U.S. Application Data
(60) Provisional application No. 60/552,360, filed on Mar. 8, 2004.

(51) Int. Cl. G06F 15/173

(52) U.S. Cl. 709/223

(57) ABSTRACT

A system and method for managing peer to peer traffic. The method includes: identifying a peer to peer request and in response providing at least one address of a peer to peer server within a cluster that is adapted to service peer to peer requests. The system includes a cluster of peer to peer servers; and a first device adapted to identify a peer to peer request and to provide at least one address of a peer to peer server within the cluster.

### FIELD OF THE INVENTION

This invention relates to a method and a device for peer to peer sharing, and especially for cache-less and caches based methods and systems.

### BACKGROUND OF THE INVENTION

The volume of peer to peer traffic has dramatically increased during the last few years. Service providers are forced to either limit the amount of peer to peer traffic or to constantly upgrade their networks in order to cope with the increasing volumes of peer to peer traffic.

Some of these upgrades include peer to peer traffic caches that store files that were provided by peers.

Some of the prior art solutions provide hardware components, such as proxies and re-directors, through which both peer to peer traffic and non-peer to peer traffic must pass. There components manipulate peer to peer traffic on the fly and are forced to operate at the line speed, thus increasing the cost and complexity of such solutions. These components are located along the critical path of the network and can dramatically decrease the network performance it they fail.

Existing prior art solutions have limited processing capabilities and are able to cope with limited amount of traffic. A first prior art solution includes redirecting all traffic to a peer to peer proxy device which determines which connections are peer to peer, and works in a similar way to a current HTTP proxy. A second prior art solution provides a virtual P2P manipulation system. This solution works inline and manipulates all connections at the L4 of the entire streams, when a P2P connection is made it is moved to a better source using inline redirection for the entire stream.

Accordingly multiple systems are located within each network segment, especially within point of presence locations. Thus, which a certain ISP network there are multiple devices. Furthermore, each point of presence has its own cache, thus decreasing the efficiency of overall caching.

U.S. patent application 2003/0208621 of Bowman titled “Path optimizer for peer to peer networks” describes prior art methods and systems for managing peer to peer traffic.

### SUMMARY OF THE PRESENT INVENTION

A method for managing peer to peer traffic, the method including: identifying a peer to peer request; and in response providing at least one address of a peer to peer server within a cluster that is adapted to service peer to peer requests.

Conveniently, the stage of providing involves providing contact information of multiple peer to peer servers, whereas at least two peer to peer servers belong to a cluster. Conveniently the method further includes caching, at the cluster, at least one peer to peer file and providing the at least one cached peer to peer file to a user. Conveniently, the caching involves applying a hash function. Conveniently, the stage of providing includes checking if the requested file is also stored outside the cluster.

Conveniently, the method further includes a stage of providing contact information of possible file sources. Conveniently, the provided contact information of possible file sources is responsive to at least one user parameter, to at least one file source parameter or to at least one path parameter or to a combination of two or more of said parameters.

Conveniently, the method further includes caching peer to peer files regardless of a request to retrieve a peer to peer file. Conveniently, the method further includes providing an encrypted file to the user. Conveniently, the file can be provided over an encrypted peer to peer network or over a HTTP download.

A system for managing peer to peer traffic, the system includes: a cluster of peer to peer servers; and a first device adapted to identify a peer to peer request and to provide at least one address of a peer to peer server or within the cluster.

Conveniently, the first device provides contact information of multiple peer to peer servers, whereas at least two peer to peer servers belong to the cluster.

Conveniently, the cluster includes multiple caching units.

Conveniently, at least one peer to peer server of the cluster determines a location of a file by applying a hash function. Conveniently, at least one peer to peer server of the cluster checks if a requested file is also stored outside the cluster.

Conveniently, at least one peer to peer server of the cluster provides contact information of possible file sources. Conveniently, the provided contact information of possible file sources is responsive to at least one user parameter, to at least one file source parameter or to at least one path parameter or to a combination of two or more of said parameters. The user parameters can be defined by the internet service provider.

Conveniently, the cluster caches peer to peer files regardless of a request, from the peer to peer cluster, to retrieve a peer to peer file. Conveniently, such caching involves monitoring other peer to peer networks that are services by other peer to peer caching devices, or are transferred by any other monitored devices.

Conveniently, at least one peer to peer server is adapted to provide an encrypted file to the user.

Conveniently, at least one peer to peer server is adapted to provide a file over HTTP to the user.

Conveniently, the cluster is located within a network operational center.

A method for managing peer to peer traffic, the method includes: providing a cache that is adapted to service peer to peer requests from a first group of users; monitoring peer to peer traffic between at least one other group of users; and selectively caching at the cache at least a portion of the monitored peer to peer traffic.

Conveniently, a cluster of processing units and caching units can operate as a web cache and serve HTTP requests to retrieve a file. This cluster can also serve peer to peer requests.

A method for managing requests to receive a file, the method includes: identifying a request to receive a file over a network; and in response providing at least one address of a server within a cluster that is adapted to service requests to receive a file.

Conveniently, the request is a peer to peer request or another request. Conveniently the cluster can act as a peer to peer cluster and/or as a web cache.

A system for managing traffic, the system includes: a cluster of servers; and a first device adapted to identify a request to receive a file over a network and to provide at least one address of a server within the cluster.

Conveniently, the cluster can operate as a web cache and/or a peer or peer cluster.

### BRIEF DESCRIPTION OF THE DRAWINGS

The present invention will be understood and appreciated more fully from the following detailed description taken in conjunction with the drawings in which:

FIG. 1 is a schematic illustration of a system for managing peer to peer traffic and of an exemplary environment, according to an embodiment of the invention;

FIG. 2 is a schematic illustration of a system for managing peer to peer traffic and of an exemplary environment, according to another embodiment of the invention;

FIG. 3 illustrates a cluster, according to an embodiment of the invention;

FIG. 4 is a schematic illustration of a system for managing peer to peer traffic and of an exemplary environment, according to a further embodiment of the invention;

### DETAILED DESCRIPTION OF PREFERRED EMBODIMENTS

The following description refers to the internet network and to internet service providers. It is noted that the disclosed methods and system can be applied in other networks, including networks that have different configurations than those described in the following figures.

The following detailed description mainly describes peer to peer traffic. It is noted that according to an embodiment of the invention the described methods and systems can also serve as a web cache and service requests to retrieve documents or content over a network. Such requests can be HTTP requests but this is not necessarily so.

For convenience of explanation a certain peer to peer protocol is described. It is noted that the invention is not limited to these specific protocol.

According to an embodiment of the invention multiple processing and caching units handle peer to peer or HTTP requests at a central point, such as an network operation center. The multiple processing and caching units are arranged in a cluster formation and manage requests at the control layer. The cluster is capable of managing a vast amount of requests. Conveniently, the cluster has a scalable formation and can be relatively easily and seamlessly increased.

According to an embodiment of the invention the cluster includes multiple processing units that operate as peer to peer and/or WEB servers. According to another embodiment the cluster also includes multiple caching units. Conveniently, the processing units and the caching units are integrated, but this is not necessarily so. Each processing unit can be associated with a single cache unit, but this is not necessarily so.

According to an embodiment of the invention the systems described herein can use a cluster of cache and processors units that can be off the shelf cache and processing units. By distributing peer to peer files between the various members of the cluster the reliability of the system increases. Thus is one member fails only a small amount of information is lost. The loss can be overcome by providing files from other sources such as users of a peer to peer network. It is noted that if a certain unit is not functional during a predefined period the files that is stored (or should have stored) can be distributed among other units. As peer to peer files do not dynamically change, this can restore the documents that were lost due to the unit malfunction.

Peer to peer users initiate a peer to peer session by an initialization stage that includes a request to receive a list of servers that can serve the peer to peer connection. Typically this list is predefined. According to an embodiment of the invention the system provides a first list that includes multiple processing units of the cluster but can include additional sources. The user software views this first list as a list of servers thus maintaining the users browsing experience.

The user software then selects one of the processing units and that processing unit manages the peer to peer request or another request. Conveniently, the cluster stores files at locations that are responsive to the signature of these files. Conveniently, the processing units apply a hashing function on the file signature and the result indicates where a file should be located. Thus, if a processing unit receives a request to retrieve a file from a user then it can apply the hashing function to determine which processing unit should provide the file. The file signature can also be referred to as a file identifier field and can be in various formats.

According to another embodiment of the invention a response to a request to retrieve a file includes a list of file sources. Conveniently, this list of file sources is provided by the processing unit that manages the peer to peer connection.

One of the files sources is the cluster, while other file sources can be other devices, such as peer devices. If a cache unit that was supposed to store the requested file fails the file can be retrieved from another file source.

According to an embodiment of the invention peer to peer files are distributed among cache units of a cluster based upon a hash function that is conveniently applied on the files signature or other identification field of that file. Thus, the file retrieval and storage processes are greatly simplified. Said hashing also enhances the scalability of the cache cluster. Conveniently, when a cache cluster receives a request to send a certain peer to peer file to a user, the cache cluster will either retrieve it from one of the cache units or will fetch it from a peer, store at a certain location within the cache cluster (in response to the hashing function), and allow the peer to peer server to fetch the file and send it to the user.

According to an embodiment of the invention the cluster can apply various filters upon requests and accordingly filter the list of file sources according to various parameters such as user related parameters and file source related parameters. The user related parameters can reflect the location of the user (local user, remote user), the quality of service associated with the user and the like. The file source related parameters can reflect the cost of retrieving the file and the like. The user related parameters and even the file related parameters can be defined by the internet service provider.

Conveniently, a file retrieval includes fetching multiple file portions from multiple file sources simultaneously. Users that are associated with higher quality of service can be provided with a list that includes more file sources, thus allowing them to receive more portions of a file in parallel. Accordingly, allowing to provide users with high quality of service or SLA.

According to an embodiment of the invention the peer to peer traffic is detected by detecting a request to receive a list of servers or by a response that includes such a list. The list of the servers (or proxies) is provided during the initial stages of a peer to peer connection.

According to another embodiment of the invention once peer to peer connection is detected the traffic is directed to a peer to peer server and conveniently to a cluster that includes multiple caching an/or processing units.

Conveniently, an first list of available processing units is dynamically updated. Typically, this stage can be implemented by a redirector (such as a level 4 redirector, a level seven redirector or other types of redirectors) and a peer to peer spoofer. Typically, after the peer to peer spoofer provides the user with the first list the connection between the user and the peer to peer spoofer is terminated.

According to another embodiment of the invention instead of using a dynamic list of peer to peer servers a level 7 switch is used to redirect all peer to peer traffic control sessions to the spoofer.

According to an embodiment of the invention the peer to peer traffic management is at least partially executed by software that is installed directly on a traffic path device, such as a smart RAS, a redirector or a pluggable router.

According to an embodiment of the invention if a file can be provided to a user from multiple file sources then the processing unit can select the optimal file source or optimal group of sources in response to the cost, quality of priority associated with the retrieval path of the file. These parameters can be taken automatically from ISP BGP tables.

According to an embodiment of the invention the processing units are able to provide certain users with files that are located in predefined peers, designated by certain IP addresses.

According to an embodiment of the invention non-peer to peer traffic is not substantially interrupt, and is does not pass via dedicated peer to peer hardware.

According to an embodiment of the invention the processing units are not connected to peer to peer caches and are capable of redirecting peer to peer requests to local peers, local inter-ISP peers or external peers though selected connections, (such as but not limited to international lines) and the like. This can be done in response to ISP defined patterns (e.g. cost of bandwidth).

According to another embodiments of the invention the cache can be used for storing information other than peer to peer files. For example, the cluster can be used as a web cache.

According to an embodiment of the invention the cluster can provide content only if the content is also stored outside the cluster. Once a request to receive a file is received from a user a processing unit will first check if the file still exists outside the cluster. This can be done based upon previously generated file source lists, as well as updated file searches.

According to another embodiment of the invention the processing unit can participate in an encrypted session. Once a request to receive a file is received the processing unit or the requesting user can initiate an encrypted session.

According to yet another aspect of the invention files are partitioned to portions (or received as portions) and the portions may be encrypted. File storage can also be performed in chunks on the same and/or different machines

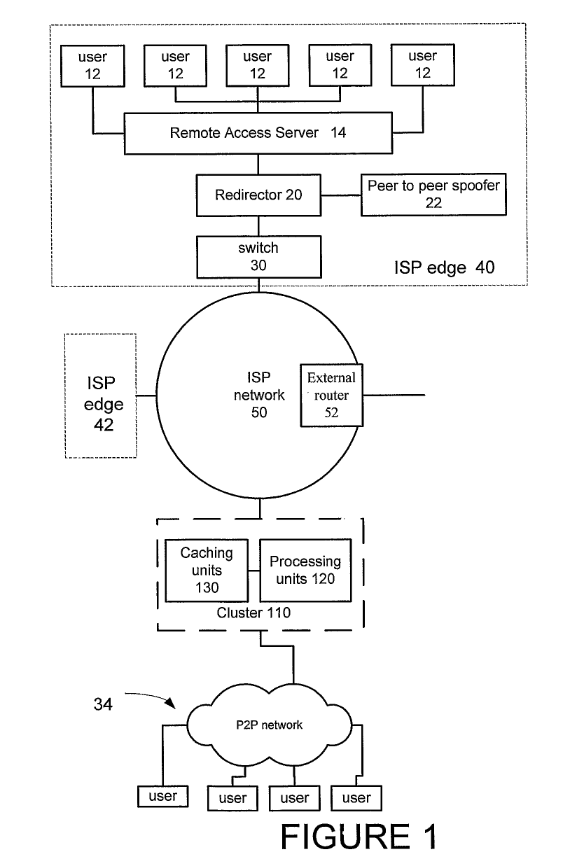

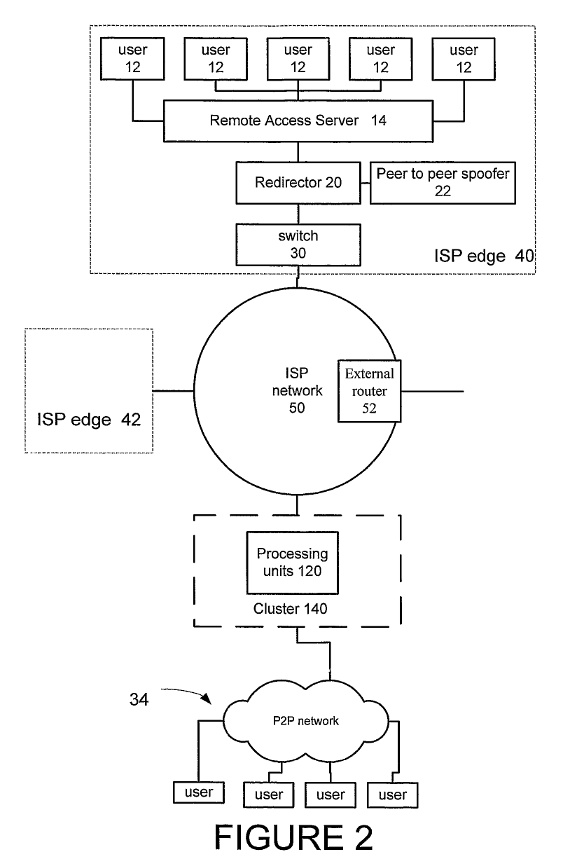

FIGS. 1 and 2 are schematic illustrations of a systems 10 and 11 for managing peer to peer traffic and of an exemplary environment 100, according to various embodiments of the invention. System 10 of FIG. 1 has a cluster 110 that includes processing units 120 as well as caching units 130 while system 11 of FIG. 2 has a cluster 140 that includes processing units 120 without caching units.

System 10 (11) includes a cluster 110 (140) and also includes a first device, such as peer to peer spoofer 22 that is adapted to identify a peer to peer request and to provide at least one address of a peer to peer server within the cluster. System 10 includes a redirector 20, a peer to peer spoofer 22, and cluster 110.

The environment 100 includes multiple users 12 that are connected to a Remote Access Server (RAS) 14. RAS 14 is connected to the redirector 20 that in turn is also connected to a switch 30. The switch 30 defines the end of an ISP edge 40. Multiple ISP edges 40 are connected to an ISP net 50. ISP net 50 includes an external router 52 that connects the ISP net 50 to other networks.

The peer to peer spoofer 22 can be a relatively simple component that may include a limited peer to peer server stack. The peer to peer spoofer 22 cooperates with redirector 20. The redirector 20 is adapted to receive a request to establish a peer to peer connection and to direct the request to the peer to peer spoofer 22. The peer to peer spoofer 22 can provide the requesting user a first list of peer to peer servers, that can include multiple processing units 120. Each processing unit 120 can service the request.

Conveniently, the redirector 20 identifies a peer to peer request by an analysis of some of the request content.

The first list that is provided by the peer to peer spoofer 22 can be dynamically updated by various manners including inspecting server connection requests, monitoring network activity and the like. Conveniently, the peer to peer spoofer 22 terminates the connection after providing the first list and the user is directed to a peer to peer server out of the list.

Each peer to peer server is conveniently connected, either directly or indirectly, multiple users that form a peer to peer network. The peer to peer network can include some of users 12 but can also include other users. Referring to FIG. 1, a peer to peer server 120 is connected to peer to peer network 34 that is illustrated as a network cloud and multiple users.

A peer to peer session usually includes two major stages that are a search stage and a file retrieval stage. The search stage provides a list of possible files, the file retrieval starts with searching for a list of sources. Once such a list is provided the file is retrieved from one or more of these possible file sources.

In a cached peer to peer system, such as illustrated in FIG. 1, a file can be cached in a peer to peer cluster 130. In such a case the list of possible file sources can include the peer to peer cluster. In some cases the peer to peer cluster 130 does not appear in the list but can be used as a source of a requested file.

A peer to peer server can act as a proxy for other peer to peer servers for a given peer to peer network, such as network 34. This includes passing user requests onwards to the peer to peer network, such as peer to peer search requests. The peer to peer server also attempts to answer search requests from a stored file source list.

When the peer to peer server detects that a file is already stored in its associated peer to peer cache cluster the file source list is updated accordingly to include the peer to peer cluster or even the cache unit within the cache cluster that stores the file.

When the cache-less configuration (such as illustrated in FIG. 2) is used, the peer to peer server can provide a list of file sources that belongs to predefined IP ranges (which are either pre-defined by the ISP, normally to its own network or may be acquired via BGP tables). Thus enabling the ISP to conserve bandwidth by allowing internal users to serve other internal users or reduce load on limited infrastructure.

According to an embodiment of the invention a system can operate in cache-less mode and a cached mode and use the same peer to peer spoofer and peer to peer server software. By using the same software the system is capable of switching instantly from the caching configuration to the non-caching configuration which allows legal flexibility for the installing ISP. The system can also have WEB server functionality.

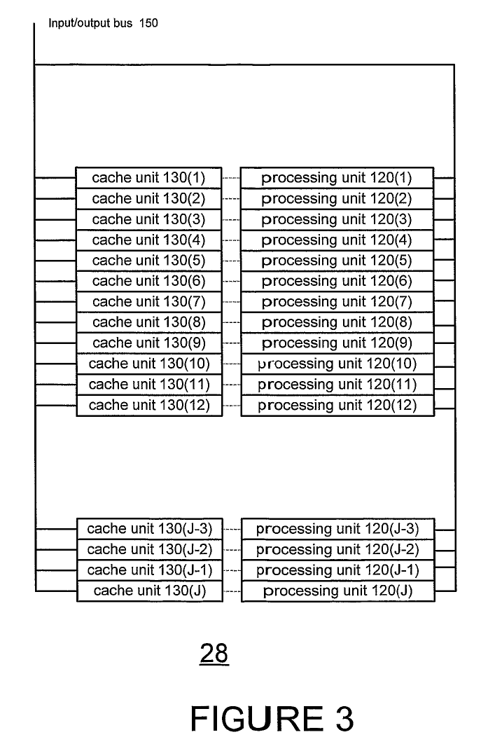

FIG. 3 illustrates a cluster 110, according to an embodiment of the invention.

The cluster 110 includes multiple processing units 120(1)-120(J) and multiple cache units 130(1)-130(J), whereas J is a positive integer that represents the number of cache units. These units are illustrated as integrated units but this is not necessarily so. It is noted that various control and data buses that connected between the units were omitted for simplicity of explanation. It is further noted that FIG. 3 illustrates a common I/O bus 150 shared by all units, but this is not necessarily so. Various switching and routing units can also be included for simplifying the routing schemes.

Each unit has caching and processing capabilities and acts as a cached peer to peer server, and/or acts as a WEB cache and a WEB proxy. Each unit is aware of the hashing function that is used to determine where to store a file. Accordingly, when a certain unit receives a request to provide a certain file it determines where this file is stored (or where such a file should be stored) and access the appropriate unit and request to receive (or fetch and the receive) the file or a portion of the file.

Conveniently, each cache unit is associated with a hash function result range (hush bucket). Since there is a unequivocal mapping between file signatures and cache units there is not need to communicate the location of the stored file between cache units.

According to an embodiment of the invention multiple cache units can be associated with the same hush function result range, thus enabling normal operation even under degraded conditions.

According to an embodiment of the invention the peer to peer cache can provide to a user a cached peer to peer file. If the peer to peer server finds that the file is not cached in the peer to peer cache cluster then it tries to locate the file in the peer to peer network connected to that server.

Conveniently, the cluster is based upon relatively simple off the shelf components. The inventors found out that the 100% availability of the cached files is not crucial and may always be gathered from the peer to peer network again. Accordingly, the cache cluster can be simplified as the cache is not required to maintain a 100% uptime per building block. Furthermore, various cache units can occasionally fail without any noticeable performance degradation.

The inventors also noted that a cluster of standard cache units can handle high loads with relative ease even though the single cache units are not necessarily optimized to handle large amount of user requests.

According to an embodiment of the invention the cluster can cache files not just in response to requests received from users 12. It can monitor various networks, including peer to peer networks and determine, according to various rules, which files to cache. These rules can be responsive to file topics, the amount of file downloads, user preferences, users profiles, and the like.

According to an embodiment of the invention a peer to peer server serves users of a certain network but monitors peer to peer traffic in other peer to peer networks and caches files that are transferred over these networks. It is noted that this caching can be subjected to various caching rules.

Conveniently, the access to certain peer to peer files is responsive to the identity or rather the location of a user. Request from certain remote users for receiving cached files can be denied while requests from certain local users can be serviced.

Typically the ISP network is connected to other networks via one or more exterior router (not shown). The exterior router can be connected to other ISP networks, to international connections and the like. This router can be provided with a filter that prevents certain users from accessing other users that belong to distant networks or to users that are connected over costly connections. The filter (can be an IP address filter) can prevent the cluster to access various users. This can result in a private peer to peer network for certain users. Nevertheless, in order to allow the cluster or users to communicate with the users or devices outside the ISP network few holes will be punched in the filter which will allow the cluster to connect to a few predefined devices.

According to an embodiment of the invention the cluster can determine (for example by viewing routing information such as BGP tables) which IP addresses are not used and assign its processing units with these addresses. This can be done dynamically. Thus the user (or another entity) will not view the cluster as belonging to the ISP network.

The cluster can also use IP addresses used by original file distributors, assuming that they only act as peer to peer P2P service station, by redirecting their ISPs to the clustered systems, either by routing methods (cheaper) or by L7 methods.

This may be done by connecting the systems to the IGP protocol running inside the ISP cloud, when such a source is detected, it may be scanned for the existence of other services, when no such services exist one of the clustered systems will take over the IP address and the system will propagate it in the IGP causing all requests to be routed to the system, while the ISP user will believe that he is connected to the remote user. Other methods to do this might be devised from this as well.

Conveniently, cache-less filtering mechanism can prioritize the access to external sources over an access to internal sources. This prioritization be provided when users that belong to the same ISP can perform extensive file sharing between themselves and saturate the internal links of the ISP. The saturation usually takes place at ISP that have limited capacity, such as cable ISP. The system also allows a new approach to Quality Of Service and SLA by using the cluster to monitor connections made by the users and number of requests made, this in combination of a connection to the ISP radius server allows the ISP to provide new ways to control users, by limiting them to downloading files no larger than a certain size, or by limiting them to a certain amount of bytes from peer to peer networks per month or even limiting them to a certain amount of files to download. Or amount of sources at the same time—speed of download

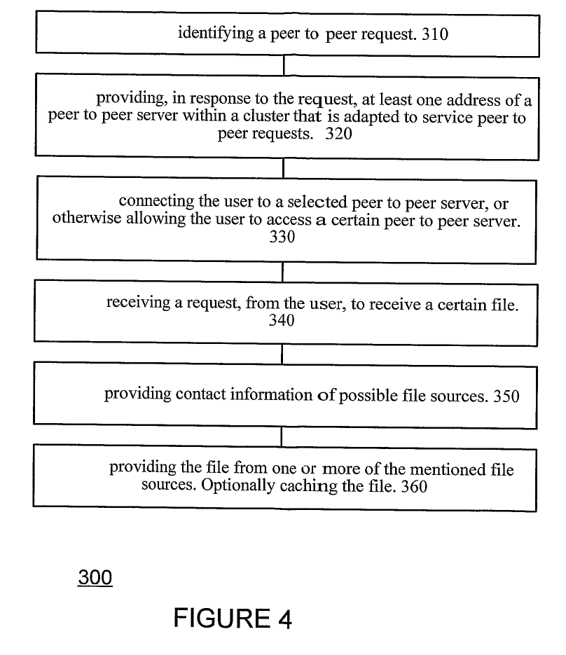

FIG. 4 illustrates a method 300 for managing peer to peer traffic, according to an embodiment of the invention.

Method 300 starts by stage 310 of identifying a peer to peer request.

Stage 310 is followed by stage 320 of providing, in response to the request, at least one address of a peer to peer server within a cluster that is adapted to service peer to peer requests. Conveniently, stage 320 includes providing contact information of multiple peer to peer servers, whereas at least two peer to peer servers belong to a cluster. This information can be provided as an initial list, but this is not necessarily so. Referring to the example set forth in FIG. 1, the peer to peer spoofer 22 identifies a request to initiate a peer to peer session and provided an initial list that includes the addresses of at least two peer to peer servers of cluster 110.

Stage 320 is followed by stage 330 of connecting the user to a selected peer to peer server, or otherwise allowing the user to access a certain peer to peer server. The selection can be done by the users software in various manners. It can be done in response to the location of that peer to peer server in the initial list, in response to a grade associated with that peer to peer server and the like. The selection can be applied in a random manner or in any other manner that can be responsive to load balancing considerations.

Stage 330 is followed by stage 340 of receiving a request, from the user, to receive a certain file.

Stage 340 is followed by stage 350 of providing contact information of possible file sources. This can involve providing a list of possible file sources. According to an aspect of the invention the list can be filters in response to one or more parameters. Typically, fewer file sources of a certain quality will provide a lower quality of service than a larger number of file sources of the same quality. Conveniently, the provided contact information of possible file sources is responsive to at least one user parameter. Conveniently, the provided contact information of possible file sources is responsive to at least one file source parameter or path parameter.

It is noted that the file sources can include a cache unit from a cluster that may include the peer to peer server.

Stage 350 is followed by stage 360 of providing the file from one or more of the mentioned file sources. Usually, the provision of a file from the cluster is more efficient and less expensive. Typically, when multiple file portions are retrieved from multiple file sources the cluster will provide a relatively large amount of portions.

Conveniently, stage 360 includes caching, at the cluster, at least one peer to peer file, if the file is not present in the cluster.

Conveniently stage 360 includes caching files regardless of a request to retrieve a peer to peer file. Thus, even files that were not requested from the cluster are cached.

According to an embodiment of the invention the file is stored at a location within the cache that is determined by applying a hashing function on the files signature.

Conveniently, stage 360 of providing includes checking if the requested file is also stored outside the cluster. In some cases the cluster can decide not to provide a file unless it is also stored outside the cluster. These cases can be determines by the cluster administrator.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for managing peer to peer traffic, the method comprising: identifying a peer to peer request; and in response providing at least one address of a peer to peer server within a cluster that is adapted to service peer to peer requests.

2. The method according to claim 1 wherein the stage of providing involves providing contact information of multiple peer to peer servers, whereas at least two peer to peer servers belong to a cluster.

3. The method according to claim 1 further comprising caching, at the cluster, at least one peer to peer file and providing the at least one cached peer to peer file to a user.

4. The method according to claim 1 wherein the caching involves applying a hash function.

5. The method according to claim 1 wherein the stage of providing comprises checking if the requested file is also stored outside the cluster.

6. The method according to claim 1 further comprises a stage of providing contact information of possible file sources.

7. The method according to claim 6 wherein the provided contact information of possible file sources is responsive to at least one user parameter.

8. The method according to claim 6 wherein the provided contact information of possible file sources is responsive to at least one file source parameter or path parameter.

9. The method of claim 1 further comprising caching peer to peer files regardless of a request to retrieve a peer to peer file.

10. The method according to claim 1 further comprising providing an encrypted file to the user.

11. A system for managing peer to peer traffic, the system comprises: a cluster of peer to peer servers; and a first device adapted to identify a peer to peer request and to provide at least one address of a peer to peer server within the cluster.

12. The system according to claim 11 first device provides contact information of multiple peer to peer servers, whereas at least two peer to peer servers belong to the cluster.

13. The system according to claim 11 wherein the cluster comprises multiple caching units.

14. The system according to claim 11 wherein at least one peer to peer server of the cluster determines a location of a file by applying a hash function.

15. The system according to claim 11 wherein at least one peer to peer server of the cluster checks if a requested file is also stored outside the cluster.

16. The system according to claim 11 wherein at least one peer to peer server of the cluster provides contact information of possible file sources.

17. The system according to claim 16 wherein the provided contact information of possible file sources is responsive to at least one user parameter.

18. The system according to claim 16 wherein the provided contact information of possible file sources is responsive to at least one file source parameter or path parameter.

19. The system of claim 11 wherein the cluster caches peer to peer files regardless of a request to retrieve a peer to peer file.

20. The system according to claim 11 wherein at least one peer to peer server is adapted to provide an encrypted file to the user.

21. The system according to claim 11 wherein the cluster is located within a network operational center.

22. A method for managing peer to peer traffic, the method comprising: providing a cache that is adapted to service peer to peer requests from a first group of users;
monitoring peer to peer traffic between at least one other group of users; and selectively caching at the cache at least a portion of the monitored peer to peer traffic.

23. A method for managing requests to receive a file, the method comprising: identifying a request to receive a file over a network; and in response providing at least one address of a server within a cluster that is adapted to service requests to receive a file.

24. The method according to claim 23 wherein the cluster is adapted to operate as a web cache.

25. The method according to claim 23 wherein the file is provided in an encrypted manner.

26. The method according to claim 23 wherein the providing include providing multiple file portions.

27. The method according to claim 23 wherein the cluster is adapted to store file portions.

28. The method according to claim 23 wherein the request is a peer to peer request.

29. The method according to claim 23 further comprising performing load balancing between members of the cluster.

30. A system for managing traffic, the system comprises: a cluster of servers; and a first device adapted to identify a request to receive a file over a network and to provide at least one address of a server within the cluster.

31. The system according to claim 30 wherein the cluster is adapted to operate as a web cache.

32. The system according to claim 30 wherein the system provides a requested file in an encrypted manner.

33. The system according to claim 30 wherein the system is adapted to provide multiple file portions.

34. The system according to claim 30 wherein the cluster is adapted to store file portions.

35. The system according to claim 30 wherein the system is adapted to service peer to peer requests.

36. The system according to claim 30 further comprising a load balancer.
